(19) United States
(12) Patent Application Publication
(10) Pub. No.: US 2009/0064808 A1
(43) Pub. Date: Mar. 12, 2009

(54) FLEXURE PIVOTS

(75) Inventors: James A. Parison, New Ipswich, NH (US); Richard F. O'Day, Westborough, MA (US)

Correspondence Address: Bose Corporation;c/o Donna Griffiths, The Mountain, MS 40, IP Legal - Patent Support, Framingham, MA, 01701, US

(73) Assignee: Bose Corporation, Framingham, MA (US)

(21) Appl. No.: 11/851,360

(22) Filed: Sep. 6, 2007

(51) Int. Cl. F16C 11/04; B60R 27/00

(52) U.S. Cl. 74/1 R

(57) ABSTRACT

A force producing element produces a force along a force axis between a plant and a support. Flexure pivots flexibly secure the force producing element to the plant and the support. The flexure pivots transmit the force between the plant and the support while isolating the force producing element from external forces.

### FIELD

This disclosure relates to flexure pivots.

### BACKGROUND

Mechanical joints, such as ball joints and rotary bearing joints, are often used in isolation and other control systems to provide pivoting points. Over time, these mechanical pivot structures can, wear and their stiffness and backlash (e.g., play or clearance) properties can become undesirable. Such pivot structure wear over time can cause instability in the dynamics of a control system.

### SUMMARY

In one general aspect, an apparatus, comprises a force producing element that produces a force along a force axis between a plant and a support. The apparatus further comprises flexure pivots flexibly securing the force producing element to the plant and the support. The flexure, pivots transmit the force between the plant and the support while isolating the force producing element from external forces.

Implementations may include one or more of the following features. For example, the plant can include a vehicle seat. The support can include a base plate to be mounted to a vehicle interior. The force producing element can include an actuator. The force producing element can include a passive suspension element.

The flexure pivots can isolate the force producing element from rotational forces about the force axis. The flexure pivots can isolate the force producing element from external forces about axes orthogonal to the force axis.

The flexure pivots can be arranged in a gimbals orientation. At least two of the flexure pivots can be disposed at approximately 90 degrees with respect to each other around the force axis. Each flexure pivot can be configured to bend with a zero stress gradient over the flexure pivot.

Each flexure pivot can be substantially I-beam shaped. Each flexure pivot can include a horizontally-arranged rectangular top flange disposed in a first plane. Each flexure pivot can include a horizontally-arranged rectangular bottom flange disposed parallel to the top flange in a second plane below the first plane. Each flexure pivot can include a vertically-arranged rectangular web centrally disposed between the top and bottom flanges. The web has at least one of: a width less than widths of the top and bottom flanges, and a thickness less than thicknesses of the top and bottom flanges. The flexure pivots include metal or alloy flexure pivots.

In another general aspect, an apparatus comprises a rigid gimbals frame for securing a force producing element between a plant and a support. The force producing element produces a force between the plant and the support along a primary force axis. The apparatus further comprises at least one flexure pivot located at the rigid gimbals frame, the at least one flexure pivot flexibly securing the force producing element to the plant and the support. The at least one flexure pivot transmits the force between the plant and the support while isolating the force producing element from external forces.

Implementations may include one or more of the following features. For example, the at least one flexure pivot can isolate the force producing element from external forces about the force axis and axes orthogonal to the force axis.

The rigid gimbals frame can be rectangular in shape and can include two parallel sides defining a length of the gimbals frame and two parallel sides defining a width of the gimbals frame. The at least one flexure pivot can be located at a center point of a side.

The apparatus can further comprise an additional rigid gimbals frame for securing the force producing element between the plant and the support. The rigid gimbals frames can be located in proximity to different ends of the force producing element. The apparatus can further comprise at least one additional flexure pivot located at the additional rigid gimbals frame.

In another general aspect, an apparatus comprises a structure located between a plant and a support. The apparatus further comprises flexure pivots flexibly securing, via the structure, the plant and the support. The flexure pivots transmit a force between the plant and the support while allowing, relative movement between the plant and the support.

Implementations may include one or more of the following features. For example, the flexure pivots can isolate the structure from rotational forces about an axis.

In another general aspect, a flexure pivot comprises a horizontally-arranged top portion disposed in a first plane. The flexure pivot comprises a horizontally-arranged bottom portion disposed substantially parallel to the top portion in a second plane situated a distance below the first plane. The flexure pivot comprises a vertically-arranged web interconnecting the top and bottom portions at or near central locations of the top and bottom portions. The web has at least one of: (i) a width less than a width of the top portion and less than a width of the bottom portion, and (ii) a thickness less than a thickness of the top portion and less than a thickness of the bottom portion.

Implementations may include one or more of the following features. For example, the vertically-arranged web can bend in response to an application of force. The top portion, the bottom portion and the web can form an I-beam shape. The top portion and the bottom portion can include fastening means for fastening the flexure pivot to a supporting structure and an actuation device.

In another general aspect, a control system comprises a controller for receiving data signals from a sensor and generating control signals. The control system comprises an actuator for receiving the control signals and, in response to the control signals, influencing a behavior of a plant using an actuation force applied to the plant along an axis. The control system comprises flexure pivots for securing the actuator to the plant and isolating the actuator from external forces around the axis.

Implementations may include one or more of the following features. For example, the plant can include a vehicle seat. The flexure pivots can be substantially I-beam shaped.

Other features and advantages will be apparent from the following description and the claims.

### BRIEF DESCRIPTION OF THE DRAWINGS

FIG. 1 is a block diagram of an example system.

FIG. 2 is a perspective view of an example actuator assembly.

FIG. 3 is a diagram of an example control system.

FIGS. 4A and 4B are diagrams of example suspension systems.

FIGS. 5A and 5B are views of an example flexure pivot configuration.

FIG. 6 is a view of an example flexure pivot configuration.

### DESCRIPTION

In some examples, flexure pivots may secure a force producing element (such as an actuator) in a control system (such, as an active or passive vehicle seat suspension). The flexure pivots can transmit a force from the force producing element to one or more other external elements, such as a vehicle seat or other plant. The flexure pivots can provide high stiffness in the direction of the transmitted force (e.g., a vertical direction), with zero backlash and wear (or without substantial backlash and wear). The flexure pivots can be arranged in a gimbals orientation to avoid adding height to the system.

In some examples, the flexure pivots can transmit force to elements having constrained motion. The flexure pivots can be used, for example, with a vehicle seat that is constrained by a bearing system to move along a set path (e.g., a linear path or a curvilinear path). In some examples, movement of the force producing element may be constrained along a set path. As an example, an actuator may have a bearing system that constrains actuation along a curvilinear path.

To accommodate such motion constraints, the flexure pivots can provide stiffness in a direction (e.g., a vertical direction) of the force produced by the force producing element while providing flexibility in other directions (e.g., translation and rotation). The flexure pivots can be flexibly constructed to bend or flex in response to various forces (e.g., load, rotation, etc.). The flexure pivots can transmit forces produced by the force producing element in a primary force direction while isolating or de-coupling the force producing element, from external forces and stresses (e.g., rotational forces and orthogonal forces) caused by the system (e.g., movement of the vehicle seat). This avoids over-constrained or redundant bearing systems.

The flexure pivots can be configured to support actuation loads without exceeding the endurance limit of the particular flexure material selected. This may ensure a near-infinite usable life. The flexure pivots can also be constructed to avoid exceeding the buckling limit for the particular geometry and load condition.

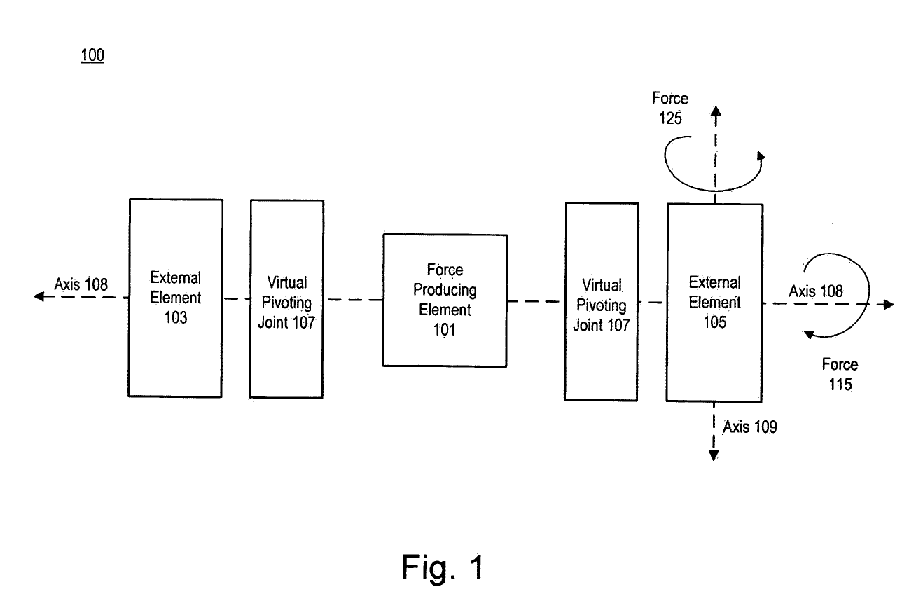

FIG. 1 illustrates, by way of functional blocks, an example system 100 in which flexure pivots can be implemented. The system 100 can include a force producing element 101 interposed between an external element 103 and an external element 105. A virtual pivoting joint 107 can be disposed between the force producing element 101 and the external elements 103, and another virtual pivoting joint 107 can be disposed between the force producing element 101 and the external element 105. The arrangement of elements illustrated in FIG. 1 is an example, and various other arrangements and/or elements can be used.

The force producing element 101 can include any element operable to generate, produce or provide a force, such an actuator, a shock absorber or strut, a spring, etc. In some examples, the force producing element 101 can be “active” in that it generates forces (e.g., actuation forces) independent of the position and the motion of the external elements 103 and 105. In some examples, the force producing element 101 can be “passive” in that it generates forces (e.g., damping forces) that are dependent on the position and motion of the external elements 103 and 105.

In some examples, movement of the force producing element 101 can be constrained along a set path. As an example, an actuator may have a bearing system that constrains actuation along a curvilinear path.

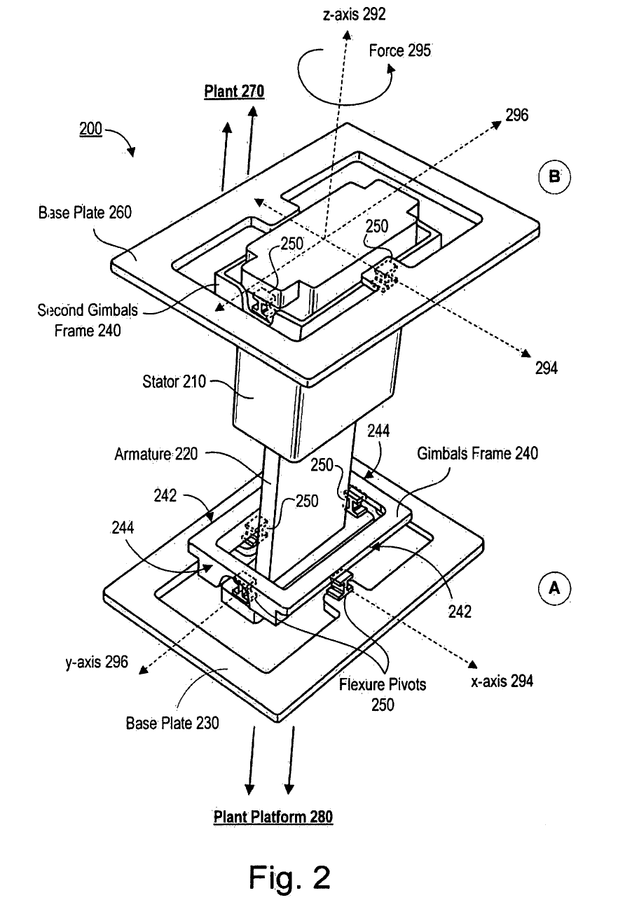

The external elements 103 and 105 can include any element or process to which forces from the force producing element 101 are to be applied. The external element 103 can be similar to the external element 105, or the external elements can be different. In some examples, as discussed below in connection with FIG. 2, the external elements 103 and 105 can include a plant (such as a vehicle seat) and a plant support (such as a vehicle floor). In some examples, the external elements 103 and 105 can include various components in test equipment, industrial machines, linear motors, medical devices or health products. Other alternatives are also possible.

In some examples, the external elements 103 and 105 can move relative to each other. For example, in a vehicle application, a vehicle seat and the vehicle floor can move relative to each other. The motion of one or more of the external elements 103 and 105 can be constrained by one, or more bearings or other constraints. As an example, a vehicle seat can be constrained by a bearing system to move along a set linear path.

The virtual pivoting joints 107 can be disposed between the force producing element 101 and the external elements 103 and 105, respectively. Each pivoting joint 107 can include one or more flexure pivots arranged in a gimbals orientation, for example, around a rigid gimbals frame. Additional details of example flexure pivot configurations are discussed below in connection with FIGS. 2-6.

The virtual pivoting joints 107 can transmit forces from the force producing element 101 to the external elements 103 and 105. The virtual pivoting joints 107 can be configured to provide stiffness along a direction of a force generated from the force producing element 101. The virtual pivoting joints 107 can be configured to provide flexibility in response to various external forces and stresses (e.g., load, rotation, etc.) from the system 100. The virtual pivoting joints 107 can be configured to transmit force from the force producing element 101 while isolating or de-coupling the force producing element 101 from the external elements 103 and 105.

In some examples, the virtual pivoting joints 107 can transmit forces produced by the force producing element 101 along a primary force axis 108. The virtual pivoting joints 107 can isolate the force producing element 101 from external forces and stresses (e.g., rotational forces and orthogonal forces) caused by the system (e.g., movement of the vehicle seat). For example, the virtual pivoting points 107 can isolate the force producing element 101 from rotational forces, such as a force 109, resulting from the external element 103 and/or the external element 105 rotating about the primary force axis 108. The virtual pivoting joints 107 can also isolate the force producing element 101 from a force 125 resulting from the external elements rotating about an axis 109 that is orthogonal to the primary force axis 108.

FIG. 2 illustrates an example actuator assembly 200. In some examples, the force producing element 101 can include all or a portion of the actuator assembly 200. As illustrated in FIG. 2, the actuator assembly 200 may include a stator 210 that surrounds an armature 220, which together form an actuator. In operation, current flows through a winding or coil (not shown) of the stator 210 and generates a magnetic field that controls movement of the armature 220 (which can be, for example, conductive or magnetic) along a primary force axis. The armature 220 can move along one or more axes in response to fields generated by the stator 210. In some examples, as illustrated in FIG. 2, the armature 220 can move axially along a z-axis 292, which runs vertically through the center of the stator 210. Alternatively, the stator 210 can move relative to the armature 220 along the z-axis 292.

The actuator assembly 200 is not limited to the configuration illustrated in FIG. 2. The actuator assembly 200 can include single or multi-phase electromagnetic actuators, such as three-phase linear actuators, single phase linear actuators, curvilinear path actuators and variable reluctance actuators. An example of a suitable actuator is disclosed in U.S. Pat. No. 4,981,309, the contents of which are incorporated by reference here. An actuator is also described in U.S. patent application Ser. No. 11/418,345, filed May 3, 2006, entitled ACTIVE SUSPENDING, the contents of which are incorporated by reference here.

In some examples, the actuator assembly 200 can be used to regulate or otherwise influence the behavior of an external element, which can include a plant 270. The plant 270 can include, for example, any element or process whose position and motion are to be controlled. The plant 270 can include, for example, various seating elements, such as land-, air- and water-vehicle seats (e.g., car seats, boat seats, airplane seats, industrial machine seats, farming machine seats, etc.) and personal transportation device seats (e.g., wheelchairs or baby carriages). Plants 270 can also include various seating fixtures, seat supporting structures, seat accessories, seat power electronics, seat suspension elements, and the like.

In some examples, various features or structures can be attached or slaved to the motion of the plant 270. Such features and structures can include, for example, cup holders, writing surfaces, data entry/retrieval devices, receptacles, displays (e.g., a navigation display), and/or controls (e.g., pedals, levers, etc.).

The plant 270 is not limited to seats or vehicle applications. In some examples, the plant 270 can include a bed (such as those in trucks or in sleeping cars on a train), vehicle cabs, engine mounts, platforms, a structure for transporting fragile or otherwise sensitive cargo (e.g., china or crystal). The plant 270 can include a machine tool isolation table, an interferometer bench, or a photolithography table. In some implementations, the plant 270 can cover large areas. For example, on a ship it may be useful to have a barber shop or a motion-sickness recovery lounge that remains stationary as the ship pitches and rolls. The plants 270 can include various other elements.

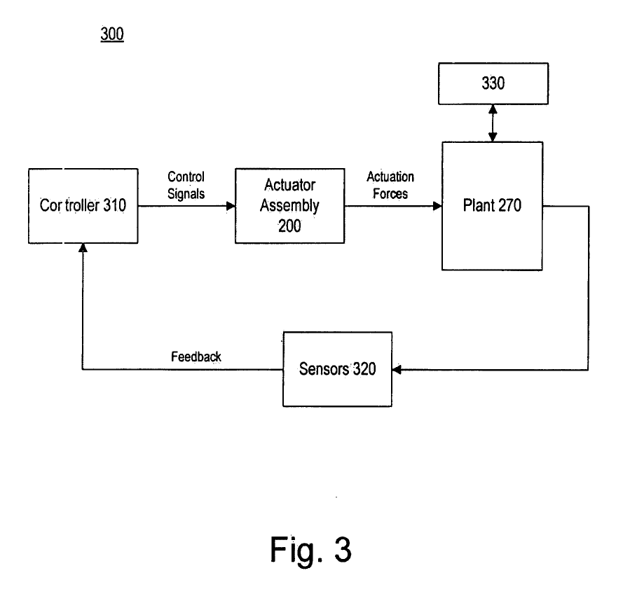

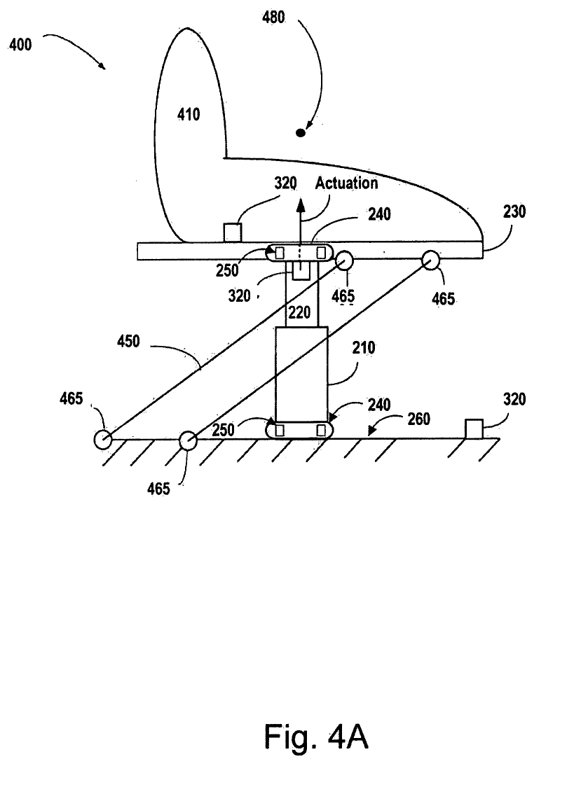

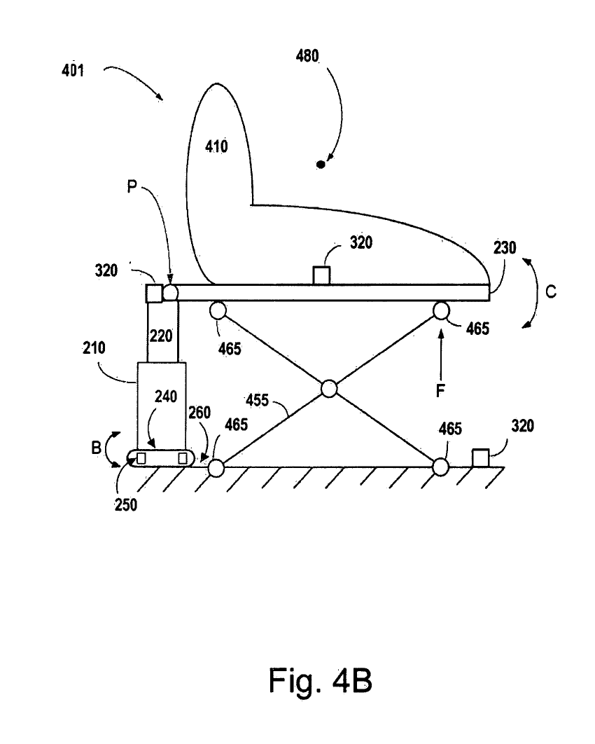

In some examples, all or part of the actuator assembly 200 can be used to implement a control system, such as an active suspension system for use with a vehicle seat. An active suspension refers, for example, to a suspension that includes an actuator or other force producing element capable of generating forces whose magnitude and direction can be controlled independently of the position and motion of the suspension. An example of an active suspension system is described in U.S. patent application Ser. No. 11/418,345, filed May 3, 2006, entitled ACTIVE SUSPENDING, the contents of which are incorporated by reference here. Additional details of an example control system are discussed below in connection with FIG. 3. Additional details of example suspension implementations are discussed below in connection with FIGS. 4A and 4B.

In some implementations, the actuator assembly 200 can operate to provide forces (e.g., via movement of the armature 220 or stator 210) at various frequencies to influence motion of the plant 270, for example, to provide suspension and vibration isolation. The actuator assembly 200 may provide forces to the plant 270 in response to commands from one or more controllers (e.g., microprocessors), which may monitor the behavior of the plant 270 (e.g., acceleration, positions, load, temperature, etc.). The controllers can be included with the actuator assembly 200 in a single housing, or the controllers can be located external to the actuator assembly 200. The controllers can communicate with the actuator assembly using wired and/or wireless communication (e.g., radio-frequency) media and channels. Additional details of an example controller are discussed below in connection with FIG. 3.

In some examples, the actuator assembly 200 can be configured to influence (e.g., suppress) motion of the plant 270 along a vertical axis and/or along a longitudinal axis. The actuator assembly 200 can apply forces to the plant 270 to reduce vibration experienced by the plant 270. In some examples, the actuator assembly 200 can operate, for example, to provide forces in response to sudden and/or gradual changes in road conditions, such as, potholes, rumble strips, or hills in the road.

As illustrated in FIG. 2, the actuator (e.g., via the armature 220) can be secured to a base plate 230 at or near (e.g., within 3-4 inches of) an end A of the actuator (e.g., the armature end). In some examples, the base plate 230 may serve to secure the actuator assembly 200 to a plant platform 280 (e.g., a vehicle interior) and support the plant 270 (e.g., a vehicle seat). The base plate 230 may include, for example, a rigid floor base plate configured to bolt into standard bolt patterns found in various vehicles. The base plate 230 is an example only. Plants 270 can be supported by any of a variety of support structures, including scissors mechanisms and various linkages.

In some implementations, the actuator can be secured to a base plate 260 at or near (e.g., within 3-4 inches of) an end B of the actuator (e.g., the stator end). In some examples, the base plate 260 may serve to secure the actuator assembly 200 to the plant 270. The base plate 260 can include a rigid frame or plate configured to bolt or otherwise fasten to the plant 270. The actuator assembly 200 can apply forces to the plant 270 by the connections of the armature 220 to the base plate 260 and the plant 270.

The actuator can be secured to the base plate 230 by way of a first gimbals frame 240 and one or more flexure pivots 250. In some examples, as illustrated in FIG. 2, the gimbals frame 240 may be substantially rectangular in shape. The gimbals frame 240 may include two parallel sides 242 that define a length of the gimbals frame 240 and an x-axis 294 of rotation at their center. The gimbals frame 240 may also include two parallel sides 244 that define a width of the gimbals frame 240 and a y-axis 296 of rotation at their center. The x-axis 294 and the y-axis 296 may be orthogonal to one another. The particular configuration of the gimbals frame 240 can be selected based on the particular frame strength desired. The gimbals frame 240 can be constructed, for example, in a six-inch square configuration using four (4) pieces of ¾-inch or 1-inch angle iron. The gimbals frame 240 is not limited to the particular configuration depicted in FIG. 2, and it may be implemented in various shapes and sizes.

In the implementation shown in FIG. 2, a first pair of flexure pivots 250 can be disposed on opposing sides of the armature 220 and along the x-axis 294 of the first gimbals frame 240, which runs through the center of the y-direction parallel sides 242. In some examples, the first pair of flexure pivots 250 can be disposed approximately 180 degrees from each other along the x-axis 294. The first pair of flexure pivots 250 can be interposed between the base plate 230 and the gimbals frame 240 to secure the gimbals frame 240 to the base plate 230.

A second pair of flexure pivots 250 can be disposed on opposing sides of the armature 220 and along the y-axis 296 of the gimbals frame 240, which runs through the center of the x-direction parallel sides 244. The second pair of flexure pivots 250 can be disposed approximately 180 degrees from each other along the y-axis 296. In this fashion, four flexure pivots 250 can be arranged approximately 90 degrees from each other at four pivot points on the gimbals frame 240. The second pair of flexure pivots can be disposed on the same plane as the first flexure pivot pair or on a different plane (e.g., a lower plane). The second pair of flexure pivots 250 can be interposed between the armature 220 and the gimbals frame 240 to secure the gimbals frame 240 to the armature 220. The arrangement of the first and second flexure-pivot pairs can provide a virtual pivoting joint (e.g., virtual pivoting joint 107) at or near the end A of the actuator and can be used to secure the actuator, to the base plate 230.

The flexure pivots 250 can be attached to the gimbals frame 240, the actuator and the base plate 230 using a variety of fasteners, such as snap fits, rivets, bolts, screws, pins, adhesives, welds, or clamps.

The actuator can be secured to the base plate 260 by a second gimbals frame 240 and one or more flexure pivots 250. That is, the assembly 200 may include two gimbals frames 240, the first gimbals frame 240 in proximity to the base plate 230 (e.g., which can attach to a vehicle or other platform) in proximity to the end A of the actuator and the second gimbals frame 240 in proximity to the base plate 260 near the end B of the actuator.

The gimbals frame 240 near the base plate 260 may be similar to the gimbals frame 240 near the base plate 230. A pair of flexure pivots 250 can be disposed approximately 180 degrees from each other along an x-axis 294 of the second gimbals frame 240, which runs through the center of the y-direction parallel sides 242. The pair of flexure pivots 250 can be interposed between the base plate 260 and the second gimbals frame 240 to secure the second gimbals frame 240 to the base plate 260. Another pair of flexure pivots 250 can be disposed approximately 180 degrees from each other along a y-axis 296 of the second gimbals frame 240, which runs through the center of the x-direction parallel sides 244. This second pair of flexure pivots 250 can be disposed on the same plane as the first flexure pivot pair or on a different plane (e.g., a lower plane). The second pair of flexure pivots 250 can be interposed between the actuator (e.g., the stator 210) and the second gimbals frame 240 to secure the second gimbals frame 240 to the actuator. As with the first gimbals frame 240, four flexure pivots 250 can be arranged approximately 90 degrees from each other at four pivot points on the second gimbals frame 240. This arrangement of the flexure pivots 250 provides a virtual pivoting joint (e.g., virtual pivoting joint 107) at or near the end B of the actuator and can be used to secure the actuator to the base plate 260.

The flexure pivots 250 can attach to the second gimbals frame 240, the actuator and the base plate 260 using various fastening mechanisms, such as snap fits, rivets, bolts, screws, pins, adhesives, welds, clamps, and the like. The flexure pivots 250 disposed around the second gimbals frame 240 can be secured in the same manner or in a different manner as that in which the flexure pivots 250 disposed around the first gimbals frame 240 are secured.

The gimbals orientation of the flexure pivots 250 can provide a virtual pivoting joint (e.g., a virtual ball joint) at both ends A and B of the actuator. The flexure pivots 250 can provide pivoting joints that are stiff in the direction of actuation (the z-direction) with zero backlash (or without substantial backlash). The flexible configuration of the flexure pivots 250 serves to reduce or eliminate friction, backlash and wear, which ensures that the plant dynamics remain steady over time.

The flexure pivots 250 can be situated so that they do not add significant (or any) height to the actuator system. As an example, a standard ball joint or other solid joint (e.g., a revolute bearing) at each end (A and B) of the actuator would add height to the overall system, which can be problematic when installing an actuator under vehicle seat, for example. The gimbals orientation of the flexure pivots 250, as illustrated in FIG. 2, can provide pivots at each end (A and B) of the actuator without adding such height. The flexure pivots 250 also reduce or eliminate the transmission of torque due to friction that may occur with standard ball joints.

Whereas solid joints (e.g., gimbals with revolute bearings) may be limited to x-y rotation, the flexure pivots 250 can allow rotation about the z-axis 292, which is in the direction of actuation. This can provide isolation from twisting or rotational forces, such as rotational force 295. For example, the flexure pivots 250 can substantially isolate the actuator from twisting forces resulting from the base plate 230 and/or the base plate 260 rotating around the z-axis 292. The flexure pivots 250 can isolate the actuator from such twisting forces as the armature 220 axially traverses the primary force axis (the z-axis 292) to provide actuation forces to the plant 270.

The flexure pivots 250 can be constructed using various types of natural, synthetic and/or engineered (e.g., composite) materials. In some example, the flexure pivots 250 can include natural or synthetic polymer materials, such as various plastics, polyimide polymers, elastomers (e.g., rubber), and the like. In some examples, the flexures pivots 250 can be constructed using, one or more DuPont™ Vespel® polyimide or other available products. In addition, or as an alternative, the flexure pivots 250 can be constructed from metals and/or alloys (e.g., stainless steel). Various other materials can be used, depending on the particular application. In some implementations, the flexure pivots 250 can be self-healing. For example, the flexure pivots 250 can be constructed from a material that is capable of repairing its own weaknesses, such as small cracks in its surface.

The flexure pivots 250 can be formed using a variety of manufacturing processes. In some examples, a flexure pivot 250 can be a stamped part that is bent and tumbled. Other processes can also be used to form the flexure pivots 250, such as injection molding, thermoforming (e.g. vacuum forming, pressure forming, etc.), extrusion, welding, shearing, rolling, stretching and the like.

The particular material, configuration and manufacturing of the flexure pivots 250 can be selected based on various application conditions and desired flexure pivot characteristics. For example, the construction of the flexure pivots 250 can be based an the axial force of the actuator, temperature conditions, geometric and spacing constraints, actuation and other loads, a desired cycle life, desired elasticity, desired tensile strength, desired buckling characteristics, and the like.

In some examples, the flexure pivot 250 can be appropriately configured and arranged to ensure that bending occurs in a middle region of the flexure. As an example, the flexure pivot 250 can be formed in an I-beam or dog-bone shape, with two horizontal flanges and a vertical web. The horizontal flanges can have a larger width or radius with respect to the vertical web, which may be formed as a web of constant thickness. Various other shapes can also be used to implement the flexure pivots 250.

The flexure-pivot 250 can be configured so as to inhibit a first mode of buckling (bending). In some examples, the relative motion of the bases 230 can constrain the fixture pivot 250 in a way that inhibits the first mode of buckling. Flexure pivot pairs can be arranged to avoid the second mode of buckling (torsion or twisting). Constraining the first and second modes of buckling can allow for the design of smaller structures based on higher mode criteria.

In some examples, the flexure pivots 250 can be configured to withstand a high cycle life, such as 10⁹ to 10¹⁰ cycles over 25,000 hours of use. Each pivot 250 can also be configured, for example, to withstand a stress of approximately 48,000 psi (pound-force per square inch). In some examples, the formation of the flexure pivots 250 can be based on buckling characteristics.

The arrangement of elements illustrated in FIG. 2 is an example and other arrangement are possible. For example, in some implementations, the orientation of the actuator assembly 200 can be inverted or flipped so that the plant 270 is located near the end B of the assembly and the plant platform is located near the end A of the assembly. In such an implementation, the base plate 230 near the end A of the actuator assembly 200 may secure the actuator assembly 200 to the plant 270 and the base plate 260 near the end B may secure the actuator assembly 200 to the plant platform 280. When inverted, the relative movement between the various elements can change accordingly.

In some implementations, the actuator assembly 200 can be connected between two plants 270. The actuator assembly 200 can be connected to a first plant 270 at or rear the end A and a second plant 270 at or near end B. The first and second plants can be similar or different in structure and functionality.

As explained above, in some implementations, all or part of the actuator assembly 200 can be used to implement a control system. FIG. 3 illustrates an example configuration of a closed-loop control system 300. The control system 300 can be configured to regulate or otherwise influence the behavior of the plant 270. In some examples, the control system 300 can include an active suspension system for use with a vehicle seat.

The control system 300 can include a controller 310 that can monitor and control conditions of the control system 300, such as the behavior of the plant 270. In the control system 300, the actuator assembly 200 can operate to provide forces at various frequencies to influence motion of the plant 270, for example, to provide suspension and vibration isolation. The actuator assembly 200 can operate in response to commands received from the controller 310.

The controller 310 can be implemented, in some examples, using one or more integrated circuits configured with various logic. The controller 310 can receive feedback (e.g., data signals indicating acceleration, position, temperature, etc.) from one or more sensors 320.

The sensors 320 can include one or more known thermal sensors, mechanical sensors, and/or electromagnetic sensors. The sensors 320 can operate to detect or obtain information about the behavior of the plant 270, such as acceleration, position, temperature, and the like. The sensors 320 may provide to the controller 310 one or more data signals indicating the detected behavior of the plant 270. The controller 310 may then utilize the received data signals to control the actuator assembly 200.

The controller 310 can generate control signals that cause the actuator assembly 200 to exert actuation forces that affect the position of the plant 270. For example, the controller 310 can cause the actuator assembly 200 to restore the plant 270 to an equilibrium position or minimize the acceleration experienced by the plant 270.

In some examples, a force bias eliminator module 330 in communication with the plant 270 can remove bias from the actuator force control signal so as to maintain zero mean load to the actuator. The module 330 may have a dynamic characteristic of a variable low stiffness spring, which can ensure that the actuator is not fighting a spring as it tries to perform active isolation. The force bias eliminator module 330 can be implemented, for example, as an air cylinder having an associated reservoir. An example of a force bias eliminator module is described in U.S. patent application Ser. No. 11/418,345, filed May 3, 2006, entitled ACTIVE SUSPENDING, the contents of which are incorporated by reference here.

The various elements of the control system 300 may communicate using various wired and/or wired communication media and channels. In some examples, the controller 310 can receive information from the sensors 320 over a wireless communication channel and can provide control signals to the actuator assembly 200 using one or more wired connections.

In some examples, control signals generated by the controller 310 can be used to modulate an output current of an amplifier. The amplifier can be connected to a power supply, which can include a battery and/or a passive power source (e.g., a capacitive element). An example power supply circuit is disclosed in U.S. patent application Ser. No. 10/872,040, filed on Jun. 18, 2004, the contents of which are incorporated by reference here. The modulated output current can then be provided to the actuator to control operation of the actuator.

The control system 300 is not limited to the configuration illustrated in FIG. 3. For example, while the example configuration shows a single actuator assembly 200, the control system 300 can include any number of dispersed actuator assemblies 200. In such an implementation, each actuator can be configured to impart the same or a different actuation force on one or more plants 270. The control system 300 can likewise include any number of controllers 310, sensors 320 and/or plants 270.

The control system 300 is not limited to controlling suspension systems or vehicle applications. For example, the control system 300 can include other systems, such as test equipment, industrial machines, motors or medical devices.

FIG. 4A shows an example active seat suspension system 400. In some examples, the actuator assembly 200 or other force producing element 101 can be used in a vehicle seat suspension system. In the system 400, the actuator assembly 200 is positioned under a center of gravity 480 of a seat 410. The seat 410 is supported by a 4-bar linkage 450 and associated bearings 465. The linkage 450 and the associated bearings 465 may constrain the motion of the seat 410.

The top of the actuator assembly 200 (e.g., the armature 220) can be connected to a gimbals frame 240 via one or more flexure pivots 250. The gimbals frame 240 can in turn connect to the base plate 230 via one or more other flexure pivots 250. In this fashion, the flexure pivots 150 serve to secure the actuator to the base plate 230 by securing the actuator to the gimbals frame 240 and securing the gimbals frame 240 to the base plate 230. In the example illustrated in FIG. 4A, the base plate 230 connects to the seat 410.

The flexure pivots 250 can be disposed around the gimbals frame 240 to provide a virtual pivoting joint between the actuator assembly 200 and the seat 410. This virtual pivoting joint can allow the actuator assembly 200 to apply a force to the seat 410 while the seat 410 moves as constrained by the linkage 450 and the associated bearings 465.

The bottom of the actuator assembly 200 (e.g., the stator 210) is connected to a gimbals frame 240 via one or more flexure pivots 250. The bottom gimbals frame 240 can in turn connect to the base plate 260 via one, or more other flexure pivots 250. In this example, the base plate 260 can connect to a vehicle floor or other support. The flexure pivots 250 can be disposed at the bottom gimbals frame 240 to provide a virtual pivoting joint between the actuator assembly 200 and the support. This bottom virtual pivoting joint, along with the joint at the top of the actuator assembly, can allow the actuator assembly 200 to apply an actuation between the seat 410 and the support while the seat 410 and the support move relative to each other.

The system 400 can include one or more sensors 320, such as accelerometers, to detect vibrations, for example, in the floor, the base plate 260 and the actuator. In the system 400, the controller 310 can be implemented within the actuator assembly 200.

FIG. 4B illustrates an example active suspension system 401 in which the actuator assembly 200 can be implemented. In FIG. 4B, the actuator is pivotally connected to the base plate 230 at point P, where the active force (F) from the actuator is applied to the base plate 230. The joint point P is kept relatively still, for example by using a bearing. As a result, bending movements at both the actuator and the base plate 230 (shown as B and C, respectively) are, applied to the seat 410 along with force coming from the scissor linkage structure 455.

The bottom of the actuator assembly 200 (e.g., the stator 210) can be connected to a gimbals frame 240 using one or more flexure pivots 250. The gimbals frame 240 can in turn connect to the base plate 260 via one or more flexure pivots 250. The base plate 260 can connect to a vehicle floor or other support. One or more flexure pivots 250 can be disposed around the gimbals frame 240 to provide a virtual pivoting joint between the actuator assembly 200 and the support. This virtual pivoting joint can allow the actuator assembly 200 to apply an actuation force between the seat 410 and the support while the seat 410 and the support move.

In FIG. 4B, the sensors 320 can detect vibration on the floor, the base plate 260 and the actuator, respectively. The controller 310 can be implemented within the actuator assembly 200.

The gimbals orientation of the flexure pivots 250 can allow for a relatively low plant height, which is useful for example, when the plant is a seat in a vehicle. Excessive seat height, in some cases, can make positioning the actuator assembly 200 under the center of gravity of the seat more difficult.

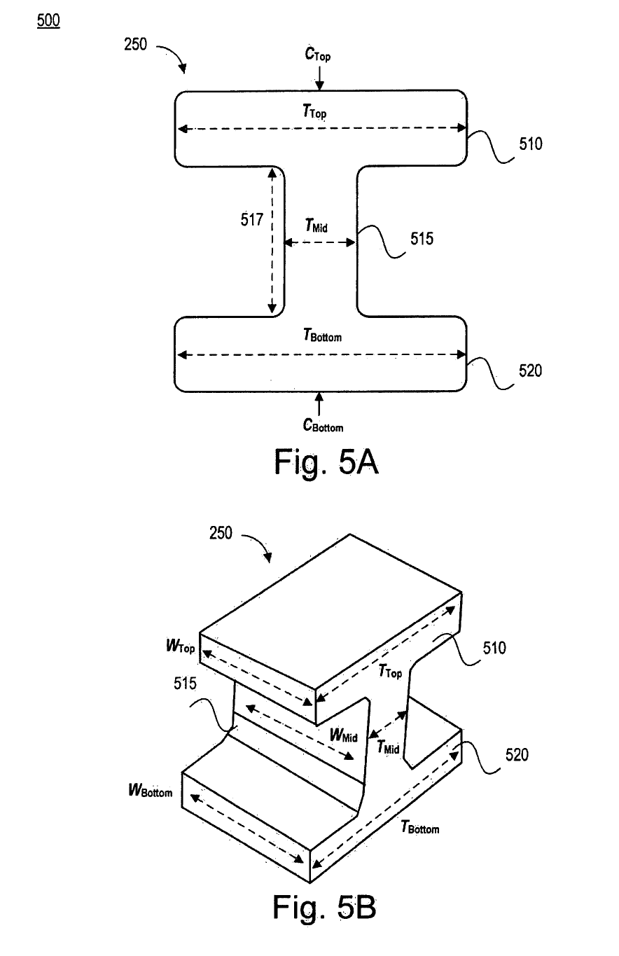

FIG. 5A and FIG. 5B illustrate an example configuration 500 of a flexure pivot 250. As illustrated in FIG. 5A and FIG. 5B, the flexure pivot 250 can include a horizontally-arranged top segment 510 and a horizontally-arranged bottom segment 520 interconnected by a vertically-arranged middle segment 515. The flexure pivot 250 can have an I-beam or dog-bone shape. Such a configuration helps to ensure proper bending in the middle segment 515 and uniform stress throughout the middle segment.

In the example configuration 500, the top segment 510 can be disposed in a first plane and the bottom segment 520 can be disposed parallel to the top segment in second plane at a distance 517 below the first plane. The top and bottom segments 510 and 520 can be rectangular. Each segment can have a thickness (T_{Top}, T_{Bottom}) in the x-direction and a width (D_{Top}, D_{Bottom}) in the y-direction. The top and bottom segments 510 and 520 can have the same or different thicknesses. The top, and bottom segments 510 and 520 can have the same or different widths.

The middle segment 515 can interconnect the top and bottom portions 510 and 520 at or near central locations (C_{Top}, C_{Bottom}) of the top and bottom portions 510 and 520. The middle segment 515 can have a thickness (T_{Mid}) less than the thicknesses of the top and bottom segments 510 and 520. The middle segment 515 can have a width (W_{Mid}) equal to or less than the widths of the top and bottom segments 510 and 520.

In some examples, the size of the flexure pivot 250 can be such that it fits within a cube that is as compact as ⅝-inch. The top, bottom and middle segments 510, 520 and 515 can be formed as a single part, or one or more of the segments can be formed individually and secured to the other segments to form the flexure pivot 250.

The configuration 500, shown in FIGS. 5A and 5B is an example only. Various other shapes and configurations can be used. A suitable shape for the flexure pivot 250 can include, for example, any shape that ensures bending in a central region and a zero stress gradient over the flexure.

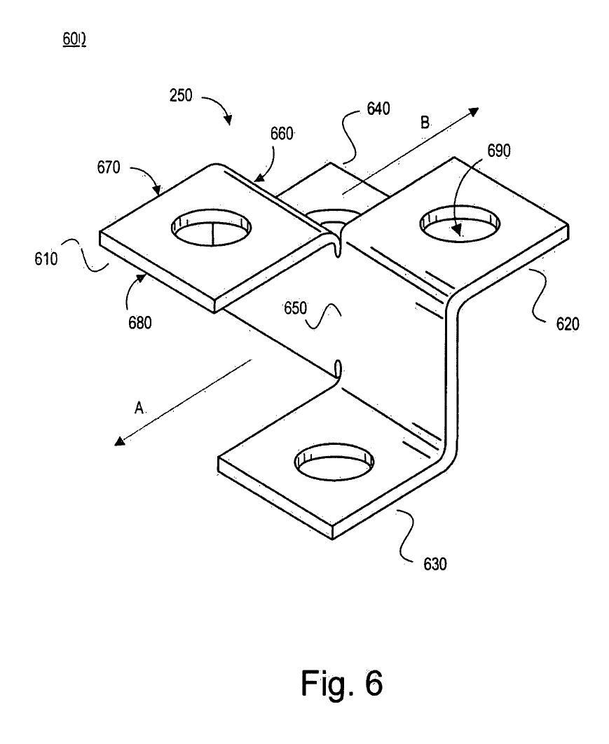

FIG. 6 illustrates another example configuration 600 of a flexure pivot 250. In the configuration 600, the flexure pivot 250 can include two horizontally-arranged, quadrilaterally-shaped upper extensions 610 and 620 and two horizontally-arranged, quadrilaterally-shaped lower extensions 630 and 640. The upper extensions 610 and 620 and the lower extensions 630 and 640 meet with a vertically-arranged central body 650, which can also be quadrilaterally-shaped. In the configuration 600, the upper and lower extensions 610, 620, 630 and 640 can be arranged so that the flexure pivot 250 is symmetric.

Each of the horizontal upper and lower quadrilateral extensions (610, 620, 630, 640) includes a proximal side 660, two opposing lateral sides 670, and a distal side 680. The proximal side 660 of each extension meets the central body 650 at an angle such that each horizontal extension extends out substantially perpendicular to the vertical central body 640. The distal sides 680 of the upper extension 610 and the lower extension 630 on one side of the flexure pivot 250 extend out from the central body 650 in the same direction (A). The distal sides 680 of the upper extension 620 and the lower extension 640 on an opposing side of the flexure pivot 250 extend out from the central body 650 in a direction (B) opposite that of the other extensions (direction A).

In some examples, each extension 610, 620, 630 and 640 can include a centrally-located opening 690. The openings 690 may be of suitable, shapes and sizes for receiving fastening elements that secure the flexure pivot 250 to the system (e.g., the base plate 260 and the gimbals frame 240). The openings 690 can be, for example, circular in shape to accommodate bolt-type and/or rivet-type fasteners.

In the configuration 600, the flexure pivot 250 can be constructed using sheet metal formed, for example, using aluminum or stainless steel. Various types of sheet metal can be used, depending on the particular application conditions and desired characteristics. In some examples, the sheet metal may be stainless steel with approximately 1/16-inch thickness. Alternatively, the flexure pivot 250 can be constructed using non-metal materials. In some examples, the sheet metal or other material may be of a suitable thickness and composition to withstand approximately 48,000 psi of stress.

In the configuration 600, the flexure pivot 250 can, for example, be a stamped part that is bent and tumbled. For example, the extensions 610, 620, 630 and 640 and the central body 650 can be a single stamped piece of sheet metal. The extensions 610, 620, 630 and 640 can be bent out at angles so that they extend out from the central body 650. After the extensions are bent, the flexure pivot 250 can be tumbled.

In some implementations, a pair of flexure pivots 250 can be provided at each pivot location to provide simultaneous tension/compression loading. Such a tension/compression flexure pair can include a first flexure pivot 250 that supports a load (e.g., from a seat) in tension. The tension/compression flexure pair can include a second flexure pivot 250 that supports the load in compression. The particular configuration and construction of the flexure pair pivots may depend on the particular application and the design requirements.

Each pivot of the tension/compression flexure pair can have the same rotation center, with one of the flexures supporting the load in tension while the other acts in compression. This configuration serves to avoid the possibility of buckling under extreme loading.

Referring again to FIG. 2, a tension/compression flexure pair (tension pivot and compression pivot) can be disposed at each of the four pivot points around the first gimbals frame 240 and around the second gimbals frame 240. The gimbals arrangement of the tension/compression flexure pairs can provide for a stiff connection at or near each end (A and B) of the actuator that can transmit force along the actuator primary force axis. The device may be free to rotate around the gimbals center.

Although FIG. 2 illustrates the flexure pivots 250 as having an I-beam shaped configuration (e.g., similar to FIGS. 5A and 5B), the flexure pivots 250 are not limited to such a configuration. The flexure pivots 250 can have the configuration 600 or another configuration in any of the environments illustrated in FIGS. 1-6. Also, tension/compression flexure pairs can be used in the various environments illustrated in the figures.

Although reference is made herein to control systems such; as vehicle seat suspensions, the flexure pivots 250 are not limited to such uses and applications. The flexure pivots 250 can be used in any situation in which a force producing element needs to be secured to an apparatus that may employ a bearing system. Some example alternative applications for the flexure pivots 250 can include test equipment, industrial machines, linear motors, medical devices (e.g., syringes) and health products. Other alternative applications are also possible.

The foregoing description does not represent an exhaustive list of all possible implementations consistent with this disclosure or of all possible variations of the implementations described. Other implementations are within the scope of the following claims.

What is claimed is:

1. An apparatus comprising:
a force producing element that produces a force along a force axis between a plant and a support; and
flexure pivots flexibly securing the force producing element to the plant and the support, the flexure pivots transmitting the force between the plant and the support while isolating the force producing element from external forces.

2. The apparatus of claim 1, Wherein the flexure pivots isolate the force producing element from rotational forces about the force axis.

3. The apparatus of claim 1, wherein the flexure pivots isolate the force producing element from external forces about axes orthogonal to the force axis.

4. The apparatus of claim 1, wherein the plant includes a vehicle seat.

5. The apparatus of claim 4, wherein the support includes a base plate to be mounted to a vehicle interior.

6. The apparatus of claim 1, wherein the force producing element includes an actuator.

7. The apparatus of claim 1, wherein the force producing element includes a passive suspension element.

8. The apparatus of claim 1, wherein the flexure pivots are arranged in a gimbals orientation.

9. The apparatus of claim 1, wherein at least two of the flexure pivots are disposed at approximately 90 degrees with respect to each other around the force axis.

10. The apparatus of claim 1, wherein each flexure pivot is configured to bend with a zero stress gradient over the flexure pivot.

11. The apparatus of claim 1, wherein each flexure pivot is substantially I-beam shaped including:
a horizontally-arranged rectangular top flange disposed in a first plane;
a horizontally-arranged rectangular bottom flange disposed parallel to the top flange in a second plane below the first plane; and
a vertically-arranged rectangular web centrally disposed between the top and bottom flanges, the web having at least one of:
a width less than widths of the top and bottom flanges, and
a thickness less than thicknesses of the top and bottom flanges.

12. The assembly of claim 1, wherein the flexure pivots include metal or alloy flexure pivots.

13. An apparatus, comprising:
a rigid gimbals frame for securing a force producing element between a plant and a support, the force producing element producing a force between the plant and the support along a primary force axis; and
at least one flexure pivot located at the rigid gimbals frame, the at least one flexure pivot flexibly securing the force producing element to the plant and the support, the at least one flexure pivot transmitting the force between the plant and the support while isolating the force producing element from external forces.

14. The apparatus of claim 13, wherein the at least one flexure pivot isolates the force producing element from external forces about the force axis and axes orthogonal to the force axis.

15. The apparatus of claim 13, wherein the rigid gimbals frame is rectangular in shape and includes two parallel sides defining a length of the gimbals frame and two parallel sides defining a width of the gimbals frame, and wherein the at least one flexure pivot is located at a center point of a side.

16. The apparatus of claim 13, further comprising:
an additional rigid gimbals frame for securing the force producing element between the plant and the support, the rigid gimbals frames located in proximity to different ends of the force producing element; and
at least one additional fixture pivot located at the additional rigid gimbals frame.

17. An apparatus, comprising:
a structure located between a plant and a support; and
flexure pivots flexibly securing, via the structure, the plant and the support, the flexure pivots transmitting a force between the plant and the support while allowing relative movement between the plant and the support.

18. The apparatus of claim 17, wherein the flexure pivots isolate the structure from rotational forces about an axis.

19. A flexure pivot, comprising:
a horizontally-arranged top portion disposed in a first plane;
a horizontally-arranged bottom portion disposed substantially parallel to the top portion in a second plane situated a distance below the first plane; and
a vertically-arranged web interconnecting the top and bottom portions at or near central locations of the top and bottom portions, the web having at least one of:
a width less than a width of the top portion and less than a width of the bottom portion, and
a thickness less than a thickness of the top portion and less than a thickness of the bottom portion.

20. The flexure pivot of claim 19, wherein the vertically-arranged web bends in response to an application of force.

21. The flexure pivot of claim 19, wherein the top portion, the bottom portion and the web form an I-beam shape.

22. The flexure pivot of claim 19, wherein the top portion and the bottom portion include fastening means for fastening the flexure pivot to a supporting structure and an actuation device.

23. A control system, comprising:
a controller for receiving data signals from a sensor and generating control signals;
an actuator for receiving the control signals and, in response to the control signals, influencing a behavior of a plant using an actuation force applied to the plant along an axis; and
flexure pivots for securing the actuator to the plant and isolating the actuator from external forces around the axis.

24. The control system of claim 23, wherein the plant includes a vehicle seat.

25. The control system of claim 23, wherein the flexure pivots are substantially I-beam shaped.
